(19) United States
(12) Patent Application Publication
(10) Pub. No.: US 2024/0053560 A1
(43) Pub. Date: Feb. 15, 2024

(54) OPTICAL FIBER CABLE STRUCTURE HAVING ROLLABLE RIBBON UNITS AND AN ELASTOMERIC LAYER

(71) Applicant: OFS Fitel, LLC, Norcross, GA (US)

(72) Inventors: Harold P Debban, Snellville, GA (US); Henson P Toland, Atlanta, GA (US); Peter A Weimann, Atlanta, GA (US)

(73) Assignee: OFS Fitel, LLC, Norcross, GA (US)

(21) Appl. No.: 18/267,439

(22) PCT Filed: Dec. 17, 2020
(86) PCT No.: PCT/US20/65503

§ 371 Date: Jun. 14, 2023

(51) Int. Cl. G02B 6/44; G02B 6/52

(52) U.S. Cl. CPC G02B 6/443; G02B 6/52

(57) ABSTRACT

Embodiments of the invention include an optical fiber cable. The optical fiber cable includes a multi-fiber unit tube that is substantially circular and dimensioned to receive a plurality of optical fibers. The optical fiber cable also includes a plurality of partially bonded optical fiber ribbon units positioned within the multi-fiber tube. The partially bonded optical fiber ribbon units are partially bonded in such a way that each partially bonded optical fiber ribbon is formed in a substantially circular shape or a random shape. The optical fiber cable also includes at least one elastomeric strength layer formed around the partially bonded optical fiber ribbon units. The optical fiber cable also includes an outer jacket surrounding the multi-fiber tube.

### BACKGROUND OF THE INVENTION

### Field of Invention

The invention relates to optical fiber cables. More particularly, the invention relates to optical fiber cables having rollable ribbon units therein.

### Description of Related Art

An optical fiber ribbon comprises two or more parallel optical fibers that are joined together along their lengths. A material commonly referred to as a matrix adheres the fibers together. In a “flat” or “encapsulated” optical fiber ribbon, the parallel optical fibers may be fully encapsulated within the matrix material.

In a partially-bonded optical fiber ribbon, also referred to as a rollable ribbon or rollable ribbon unit, the optical fibers forming the optical fiber ribbon are not bonded over their entire length. Rather, the optical fibers are bonded intermittently, thus allowing the optical fiber ribbon to be folded or rolled into an approximately cylindrical shape, allowing for better filling of a circular cable, resulting in more optical fibers included in a given cable diameter compared to optical fiber cables with conventional fully bonded ribbon structures. In addition to allowing more optical fibers to be included in a given cable diameter, rollable ribbon units provide mass fusion splicing in optical fiber cable sizes that were formerly the realm of optical fiber cables with single fibers.

An emerging optical fiber cable application is optical fiber cables designed for air blown installations to replace micro cables based on loose tube cable structures. A loose tube cable structure provides effective blowing performance in small cable ducts (e.g., cable ducts with an inside diameter of 14 millimeters or less).

Optical fiber cables with rollable ribbon units therein (i.e., rollable ribbon cables) typically have the greatest optical fiber density, i.e. the most optical fibers in a given cable diameter, when all of the rollable ribbon units are contained in a single tube in the center of the cable, often referred to as a central tube or core tube. Such configuration moves the strength from the center of the cable to the periphery of the cable. Depending on the cable structure, having the strength of the cable at the periphery of the cable can reduce the potential distance the cable can be blown.

One conventional rollable ribbon cable structure involves strength members helically applied around the circumference of the central tube. This rollable ribbon cable structure typically has a thin layer of helically applied strength members over the core tube. Such configuration results in a relatively small diameter cable structure with no preferential bending. However, an issue with this rollable ribbon cable structure is that it can only be installed for relatively short distances using cable blowing techniques if there are more than a few bends in the duct, as this rollable ribbon cable structure is not elastic in bending. The energy or force required to bend the cable structure is dissipated through the movement of the strength members within the jacket. Also, this cable structure can also buckle when pushed into the duct, resulting in more friction force with the duct.

Another conventional rollable ribbon cable structure, also referred to an LXE construction, involves multiple linear strength members. This rollable ribbon cable structure has relatively high resistance to compressive loads because the cable structure dissipates compressive loads along the length of the cable away from the application load site. This cable structure is generally elastic in bending. Also, this cable structure stores energy when the cable structure is bent and can release energy when the cable structure is release from the bend. This cable structure can be made stiff enough to prevent buckling in ducts, which gives this cable structure generally improved blowing performance over the conventional helical strength member cable structure.

However, this conventional cable structure still has issues in blown installations compared to conventional loose tube cable designs. Most cable structures of this type only bend in one plane (also known as preferential bending). To make a compound turn from the direction of travel, this cable structure must twist out of plane, taking more space inside the duct and forcing the cable structure against the duct wall, thus increasing friction or even causing jamming of the cable structure in the duct, depending on the diameter of the duct. If the linear strength members are uniformly distributed around the core tube, blowing performance is improved, but this cable structure is still relatively difficult to bend and will kink relatively easily.

### SUMMARY OF THE INVENTION

The invention is embodied in an optical fiber cable. The optical fiber cable includes a multi-fiber unit tube that is substantially circular and dimensioned to receive a plurality of optical fibers. The optical fiber cable also includes a plurality of partially bonded optical fiber ribbon units positioned within the multi-fiber tube. The partially bonded optical fiber ribbon units are partially bonded in such a way that each partially bonded optical fiber ribbon is formed in a substantially circular shape or a random shape. The optical fiber cable also includes at least one elastomeric strength layer formed around the partially bonded optical fiber ribbon units. The optical fiber cable also includes an outer jacket surrounding the multi-fiber tube.

### BRIEF DESCRIPTION OF THE DRAWINGS

FIG. 1 is a perspective view of a conventional rollable ribbon cable structure, having strength members helically applied around the circumference of the central tube;

FIG. 2 is a perspective view of another conventional rollable ribbon cable structure, having multiple linear strength members;

FIG. 3 is a perspective view of a rollable ribbon cable structure having an elastomeric inner layer, according to embodiments of the invention; and

FIG. 4 is a cross-sectional view of the rollable ribbon cable structure having an elastomeric inner layer of FIG. 3, according to embodiments of the invention.

### DETAILED DESCRIPTION OF EXEMPLARY EMBODIMENTS

In the following description like reference numerals indicate like components to enhance the understanding of the invention through the description of the drawings. Also, although specific features, configurations and arrangements are discussed hereinbelow, it should be understood that such is done for illustrative purposes only. A person skilled in the relevant art will recognize that other steps, configurations and arrangements are useful without departing from the spirit and scope of the invention.

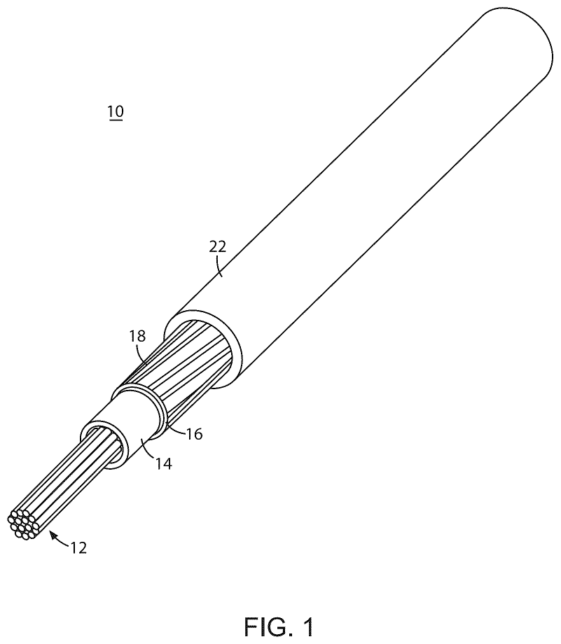

FIG. 1 is a perspective view of a conventional rollable ribbon cable structure 10, having strength members helically applied around the circumference of the central tube. The cable structure 10 includes one or more partially bonded optical fiber ribbon units 12, which are bonded intermittently, thus allowing each optical fiber ribbon unit 12 to be folded or rolled into an approximately cylindrical shape.

The partially bonded optical fiber ribbon units 12 are positioned within a multi-fiber unit tube, central tube or core tube 14. The multi-fiber unit tube 14 is substantially circular and dimensioned to receive therein the partially bonded optical fiber ribbon units 12. The multi-fiber unit tube 14 is made of polypropylene, polybutylene terephthalate (PBT), polyethylene, nylon, polycarbonate, thermoplastic polyurethane (TPU), poly(vinyl chloride) (PVC) or other suitable material or materials.

The cable structure 10 has a relatively thin layer of water block tape 16. The water block tape 16 prevents water passage between strength members 18 (discussed hereinbelow). Alternatively, the cable structure 10 includes water blocking powder or other suitable water blocking material.

The cable structure 10 also has a relatively thin layer of strength members 18 helically applied over the multi-fiber unit tube 14. The strength members 18 can be aramid yarns, fiberglass yarns or other suitable material or materials.

The cable structure 10 also has an outer jacket 22 formed around the multi-fiber unit tube 14 and the strength members 18. The outer jacket 22 is made of polyethylene, thermoplastic polyurethane, nylon 12 or other suitable material or materials.

As discussed hereinabove, the cable structure 10 is a relatively small diameter cable structure with no preferential bending. However, the cable structure 10 can only be installed for short distances using cable blowing techniques if there are more than a few bends in the duct. The cable structure 10 is not elastic in bending, and the energy or force required to bend the cable structure 10 is dissipated through the movement of the strength members 18 within the outer jacket 22. Also, the cable structure 10 can also buckle when pushed into a duct, resulting in more friction force with the duct.

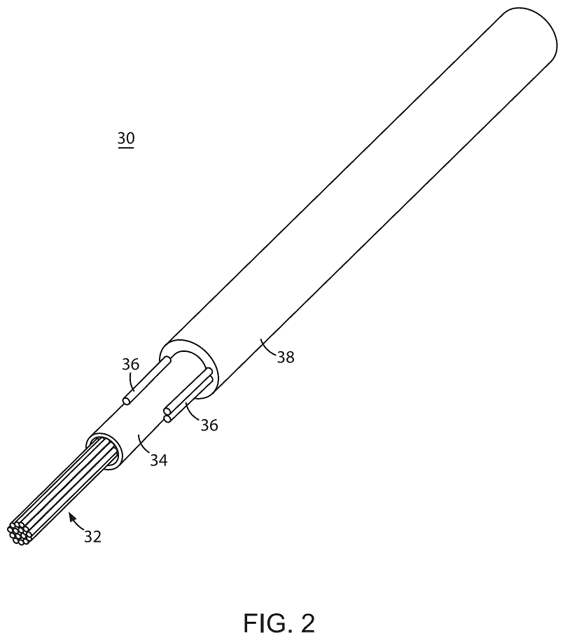

FIG. 2 is a perspective view of another conventional rollable ribbon cable structure 30, having multiple linear strength members. The cable structure 30 includes one or more partially bonded optical fiber ribbon units 32, which are bonded intermittently, thus allowing each optical fiber ribbon unit 32 to be folded or rolled into an approximately cylindrical shape.

The partially bonded optical fiber ribbon units 32 are positioned within a multi-fiber unit tube, central tube or core tube 34. The multi-fiber unit tube 34 is substantially circular and dimensioned to receive therein the partially bonded optical fiber ribbon units 32. The multi-fiber unit tube 34 is made of polypropylene, polybutylene terephthalate (PBT), polyethylene, nylon, polycarbonate, thermoplastic polyurethane (TPU), poly(vinyl chloride) (PVC) or other suitable material or materials.

The cable structure 30 also has a plurality of linear strength members 36 positioned along the outside of the multi-fiber unit tube 34. The strength members 36 can be aramid yarns, fiberglass yarns or other suitable material or materials.

The cable structure 30 also has an outer jacket 38 formed around the multi-fiber unit tube 34 and the strength members 36. The outer jacket 38 is made of polyethylene, thermoplastic polyurethane, nylon 12 or other suitable material or materials.

As discussed hereinabove, the cable structure 30 has relatively high resistance to compressive loads because the cable structure 30 dissipates compressive loads along the length of the cable structure 30 away from the application load site. The cable structure 30 is generally elastic in bending, and the cable structure 30 stores energy when the cable structure 30 is bent and can release energy when the cable structure 30 is release from the bend. The cable structure 30 can be made stiff enough to prevent buckling in ducts, which gives the cable structure 30 generally improved blowing performance over the conventional helical strength member cable structure 10.

However, the conventional cable structure 30 still has issues in blown installations compared to conventional loose tube cable designs. Most cable structures of the type of the cable structure 30 only bend in one plane (also known as preferential bending). To make a compound turn from the direction of travel, the cable structure 30 must twist out of plane, taking more space inside the duct and forcing the cable structure 30 against the duct wall, thus increasing friction or even causing jamming of the cable structure 30 in the duct, depending on the diameter of the duct. If the linear strength members 36 are uniformly distributed around the multi-fiber unit tube 34, blowing performance is improved. However, the cable structure 30 is still relatively difficult to bend and will kink relatively easily.

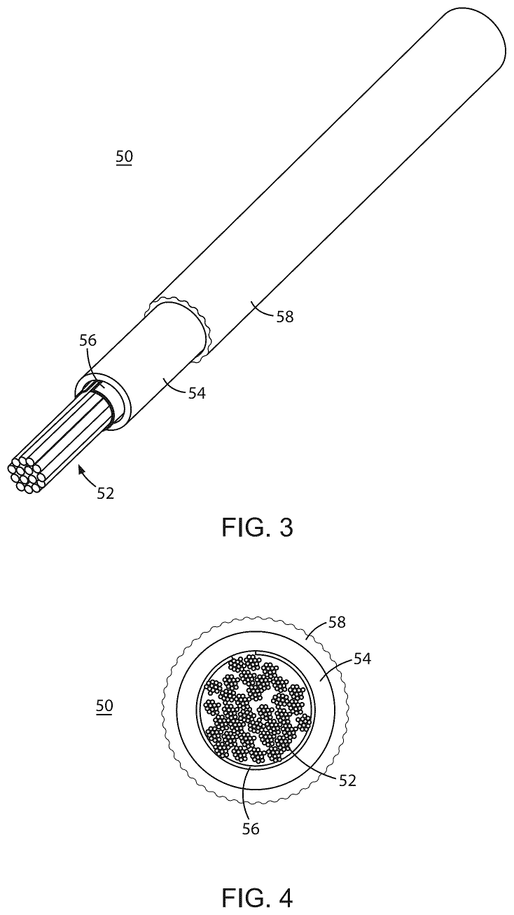

FIG. 3 is a perspective view of a rollable ribbon cable structure 50 having an elastomeric inner layer, according to embodiments of the invention. FIG. 4 is a cross-sectional view of the rollable ribbon cable structure 50 having an elastomeric inner layer of FIG. 3, according to embodiments of the invention. The cable structure 50 includes one or more partially bonded optical fiber ribbon units 52, which are bonded intermittently, thus allowing each optical fiber ribbon unit 52 to be folded or rolled into an approximately cylindrical shape or other suitable shape, including a random shape.

The partially bonded optical fiber ribbon units 52 are positioned within a multi-fiber unit tube, central tube or core tube 54. The multi-fiber unit tube 54 is substantially circular and dimensioned to receive therein the partially bonded optical fiber ribbon units 52.

The multi-fiber unit tube 54 can be made of any suitable material or materials. For example, the multi-fiber unit tube 54 can be made of polypropylene, polybutylene terephthalate (PBT), polyethylene, nylon, polycarbonate, thermoplastic polyurethane (TPU), poly(vinyl chloride) (PVC) or other suitable material or materials. Flame retardant additives may be incorporated into the multi-fiber tube 54 to help impart fire resistance, which may be desirable if some or all of the cable structure 50 is deployed inside a building. The multi-fiber unit tube 54 can be a homogeneous tube. Alternatively, the multi-fiber unit tube 54 can be a multi-layer tube produced by coextrusion.

In an embodiment, the multi-fiber unit tube 54 can has an outer diameter of approximately 6.0 millimeters (mm) and an inner diameter of approximately 5.0 mm. Such a multi-fiber unit tube 54 can house twelve partially bonded optical fiber ribbons units 52, with each partially bonded optical fiber ribbon unit 52 having twelve fibers per ribbon (144 optical fibers total).

The cable structure 50 also has an elastomeric layer 56 formed around partially bonded optical fiber ribbons units 52 or otherwise integrated into the cable structure 50. Alternatively, the elastomeric layer 56 is formed around multi-fiber unit tube 54. The elastomeric layer 56 can be made of or include thermoplastic polyurethane (TPU) or thermoplastic elastomers (TPE), or other suitable material or materials, such as styrenic block copolymers (TPS), thermoplastic copolyester (TPC) and thermoplastic polyamides (TPA). According to embodiments of the invention, the elastomeric layer 56 gives the cable structure 50 elastic bending properties without preferential bending or excessive energy dissipation.

The cable structure 50 also has an outer jacket 58 formed around the multi-fiber unit tube 54 and the elastomeric layer 56. The outer jacket 58 can be made of any suitable material or materials. For example, the outer jacket 58 can be made of polyethylene, thermoplastic polyurethane, nylon 12, or other suitable material or materials. Flame-retardant additives may be incorporated into the outer jacket 58 to impart fire resistance to the cable structure 50. In one embodiment, the outer jacket 58 is made from medium-density polyethylene (MDPE), with a nominal jacket thickness of approximately 1.2 mm, so as to comply with the ICEA-S-87-640 standard for outside plant fiber optic cables.

In an alternative embodiment, the outer jacket 58 can be a relatively low friction skin that is applied over the multi-fiber unit tube 54 using a relatively high density polyethylene, polyamide (Nylon) or other suitable material. The relatively low friction skin reduces friction between the cable structure 50 and a duct into which the cable structure 50 is blown. Alternatively, the low friction skin can have a ribbed outer surface. The low friction skin also can have a relatively low coefficient of thermal expansion, e.g., 25 to 100 microns per meter per Celsius degree (μm/m-° C.), to extend the temperature range of the cable structure 50.

In an alternative embodiment, if the cable structure 50 requires more tensile strength, a thin layer of strength members can be helically applied over the elastomeric layer 56. The thin layer of helically applied strength members improves the tensile strength of the cable structure 50 without adding an energy dissipating layer that will reduce blowing distances of the cable structure 50.

It will be apparent to those skilled in the art that many changes and substitutions can be made to the embodiments of the invention herein described without departing from the spirit and scope of the invention as defined by the appended claims and their full scope of equivalents.

1. An optical fiber cable, comprising:
a multi-fiber unit tube, wherein the multi-fiber unit tube is substantially circular and dimensioned to receive a plurality of optical fibers;
a plurality of partially bonded optical fiber ribbon units positioned within the multi-fiber tube, wherein the partially bonded optical fiber ribbon units are partially bonded in such a way that each partially bonded optical fiber ribbon is formed in a substantially circular shape or a random shape;
at least one elastomeric strength layer formed around the partially bonded optical fiber ribbon units; and
an outer jacket surrounding the multi-fiber unit tube.

2. The optical fiber cable as recited in claim 1, wherein the elastomeric strength layer is made of thermoplastic polyurethane (TPU) or thermoplastic elastomers (TPE).

3. The optical fiber cable as recited in claim 1, wherein the elastomeric strength layer is made of a material selected from the group consisting of thermoplastic polyurethane (TPU), thermoplastic elastomers (TPE), styrenic block copolymers (TPS), thermoplastic copolyester (TPC) and thermoplastic polyamides (TPA).

4. The optical fiber cable as recited in claim 1, wherein the outer jacket comprises a low friction skin applied over the multi-fiber unit tube.

5. The optical fiber cable as recited in claim 4, wherein the low friction skin has a ribbed outer surface.

6. The optical fiber cable as recited in claim 4, wherein the low friction skin has a coefficient of thermal expansion of approximately 25 to approximately 100 microns per meter per Celsius degree (μm/m-° C.).

7. The optical fiber cable as recited in claim 1, further comprising a plurality of strength members helically applied to the multi-fiber unit tube.

8. The optical fiber cable as recited in claim 7, wherein the plurality of strength members are made of aramid yarn.

9. The optical fiber cable as recited in claim 1, wherein the multi-fiber unit tube is made of a material selected from the group consisting of polypropylene, polyethylene, nylon, polycarbonate, polybutylene terephthalate (PBT), thermoplastic polyurethane (TPU) and poly(vinyl chloride) (PVC).

10. The optical fiber cable as recited in claim 1, wherein the outer jacket is made of a material selected from the group consisting of polyethylene, thermoplastic polyurethane and nylon 12.

11. The optical fiber cable as recited in claim 10, wherein the outer jacket includes at least one flame retardant additive.

12. A method for blowing an optical fiber cable into a duct, comprising:
providing an optical fiber cable, wherein the optical fiber cable comprises
a multi-fiber unit tube, wherein the multi-fiber unit tube is substantially circular and dimensioned to receive a plurality of optical fibers,
a plurality of partially bonded optical fiber ribbon units positioned within the multi-fiber tube, wherein the partially bonded optical fiber ribbon units are partially bonded in such a way that each partially bonded optical fiber ribbon is formed in a substantially circular shape or a random shape,
at least one elastomeric strength layer formed around the partially bonded optical fiber ribbon units, and
an outer jacket surrounding the multi-fiber unit tube; and
blowing the optical fiber cable into the duct.
